(19) United States
(12) Patent Application Publication
(10) Pub. No.: US 2026/0064179 A1
(43) Pub. Date: Mar. 5, 2026

(54) ELECTRONIC APPARATUS FOR REDUCING STANDBY POWER CONSUMPTION AND CONTROL METHOD THEREOF

(71) Applicant: SAMSUNG ELECTRONICS CO., LTD., Suwon-si (KR)

(72) Inventor: Beomsu JEONG, Suwon-si (KR)

(73) Assignee: SAMSUNG ELECTRONICS CO., LTD., Suwon-si (KR)

(21) Appl. No.: 19/263,926

(22) Filed: Jul. 9, 2025

Related U.S. Application Data
(63) Continuation of application No. PCT/KR2025/007356, filed on May 29, 2025.

(30) Foreign Application Priority Data
Sep. 4, 2024 (KR) 10-2024-0120234

(51) Int. Cl. G06F 1/3206; G06F 1/30

(52) U.S. Cl. CPC G06F 1/3206; G06F 1/305

(57) ABSTRACT

Provided is an electronic apparatus including: a battery; a display; memory storing instructions; a first processor configured to execute the instructions; and a second processor, wherein the first processor consumes no power in a first mode, wherein the first processor consumes power via the battery in a second mode, wherein a power consumption of the second processor is less than a power consumption of the first processor in the second mode, wherein the second processor is configured to switch the first processor from the first mode to the second mode based on an external device being connected to the electronic apparatus while the first processor is in the first mode, and wherein the instructions, when executed by the first processor, cause the apparatus to: receive content from the external device, and display the received content.

### CROSS-REFERENCE TO RELATED APPLICATIONS

This application is a by-pass continuation of International Application No. PCT/KR2025/007356, filed on May 29, 2025, which is based on and claims priority to Korean Patent Application No. 10-2024-0120234, filed in the Korean Intellectual Property Office on Sep. 4, 2024, the disclosures of which are incorporated by reference herein in their entireties.

### BACKGROUND

### 1. Field

The present disclosure relates to an electronic apparatus and a control method thereof, and more particularly, to an electronic apparatus for reducing standby power consumption and a control method thereof.

### 2. Description of Related Art

Various types of electronic apparatuses have been developed in accordance with the development of electronic technology. In particular, various types of displays have been widespread recently, thus improving user convenience.

For example, a display device including an electronic paper (ePaper) display has recently become widespread. The ePaper display has low power consumption, and the display device is thus widely used situations where the display device is not connected to an external power source.

Accordingly, power management of the display device including the ePaper display may be a critical issue.

### SUMMARY

According to an aspect of the disclosure, an electronic apparatus includes: a battery; a display; memory storing instructions; at least one first processor configured to execute the instructions, wherein the at least one first processor is operably connected to the battery, the display, and the memory; and a second processor operably connected to the battery and the at least one first processor, wherein the at least one first processor consumes no power in a first mode, wherein the at least one first processor consumes power via the battery in a second mode, wherein a power consumption of the second processor is less than a power consumption of the at least one first processor in the second mode, wherein the second processor is configured to switch the at least one first processor from the first mode to the second mode based on an external device being connected to the electronic apparatus while the at least one first processor is in the first mode, and wherein the instructions, when executed by the at least one first processor individually or collectively, cause the electronic apparatus to: receive content from the external device, and control the display to display the received content.

The second processor may be further configured to switch the at least one first processor to the first mode based on the received content being displayed on the display.

The electronic apparatus may further include a switch connecting the battery to the at least one first processor, and the second processor may be further configured to switch the at least one first processor to either the first mode or the second mode by operating the switch.

The second processor may be further configured to transmit a wake-up signal to the at least one first processor based on the external device being connected to the electronic apparatus, and the instructions, when executed by the at least one first processor individually or collectively, may further cause the electronic apparatus to: based on the at least one first processor being switched to the second mode, supply power to the display and at least one circuit connected to the at least one first processor, and based on the at least one first processor receiving the wake-up signal, cut off power to the at least one circuit.

The second processor may include a first signal pin that is at a high level, the external device may include a second signal pin that is grounded, and the second processor may be further configured to identify that the external device is connected to the electronic apparatus based on the second signal pin being short-circuited to the first signal pin, causing the first signal pin to switch to a low level.

The display may include an electronic paper (ePaper) display, and the ePaper display may be configured to maintain a display state of the displayed received content while not receiving power.

The ePaper display may be further configured to: change the display state of the displayed received content while receiving power, and not change the display state of the displayed received content while not receiving power.

The electronic apparatus may not be connected to an external power source.

The electronic apparatus may further include an input/output interface, and the external device may include a universal serial bus device connected to the electronic apparatus via the input/output interface.

The second processor may be further configured to continuously receive power via the battery.

According to an aspect of the disclosure, a method of controlling an electronic apparatus includes: switching, by a second processor of the electronic apparatus, at least one first processor of the electronic apparatus from a first mode to a second mode based on an external device being connected to the electronic apparatus while the at least one first processor is in the first mode; receiving, by the at least one first processor, content from the external device; and displaying the received content on a display of the electronic apparatus, wherein the at least one first processor consumes no power in the first mode, wherein the at least one first processor consumes power via a battery of the electronic apparatus in the second mode, and wherein a power consumption of the second processor is less than a power consumption of the at least one first processor in the second mode.

The method may further include switching, by the second processor, the at least one first processor to the first mode based on the received content being displayed on the display.

The switching the at least one first processor to the second mode may further include operating, by the second processor, a switch of the electronic apparatus connecting the battery to the at least one first processor, and wherein the method may further include: operating, by the second processor, the switch while the at least one first processor is in the second mode, thereby switching the at least one first processor to the first mode.

The switching the at least one first processor to the second mode may further include: transmitting a wake-up signal to the at least one first processor based on the external device being connected to the electronic apparatus, and the method may further include: based on the at least one first processor being switched to the second mode, supplying power to the display and at least one circuit of the electronic apparatus connected to the at least one first processor; and based on the at least one first processor receiving the wake-up signal, cutting off power to the at least one circuit.

The second processor may include a first signal pin that is at a high level, the external device may include a second signal pin that is grounded, and the switching the at least one first processor to the second mode may further include: identifying, by the second processor, that the external device is connected to the electronic apparatus based on the second signal pin being short-circuited to the first signal pin, causing the first signal pin to switch to a low level.

According to an aspect of the disclosure, a non-transitory computer readable medium has instructions stored therein, which when executed by a first processor and a second processor of an electronic apparatus, cause the electronic apparatus to execute a method of operation, the method including: switching, by the second processor, the first processor from a first mode to a second mode based on an external device being connected to the electronic apparatus while the first processor is in the first mode; receiving, by the first processor, content from the external device; and displaying the received content on a display of the electronic apparatus, wherein the first processor consumes no power in the first mode, wherein the first processor consumes power via a battery of the electronic apparatus in the second mode, and wherein a power consumption of the second processor is less than a power consumption of the first processor in the second mode.

With regard to the non-transitory computer readable medium, the method may further include switching, by the second processor, the first processor to the first mode based on the received content being displayed on the display.

With regard to the non-transitory computer readable medium, the switching the first processor to the second mode may further include operating, by the second processor, a switch of the electronic apparatus connecting the battery to the first processor, and the method may further include: operating, by the second processor, the switch while the first processor is in the second mode, thereby switching the first processor to the first mode.

With regard to the non-transitory computer readable medium, the switching the first processor to the second mode may further include: transmitting a wake-up signal to the first processor based on the external device being connected to the electronic apparatus, and wherein the method further includes: based on the first processor being switched to the second mode, supplying power to the display and at least one circuit of the electronic apparatus connected to the first processor; and based on the first processor receiving the wake-up signal, cutting off power to the at least one circuit.

With regard to the non-transitory computer readable medium, the second processor may include a first signal pin that is at a high level, the external device may include a second signal pin that is grounded, and the switching the first processor to the second mode may further include: identifying, by the second processor, that the external device is connected to the electronic apparatus based on the second signal pin being short-circuited to the first signal pin, causing the first signal pin to switch to a low level.

According to an aspect of the disclosure, an electronic apparatus includes: a battery; a display; at least one memory storing one or more instructions; a first processor configured to execute the one or more instructions, wherein the first processor is operably connected to the battery, the display, and the memory; and a second processor configured to execute the one or more instructions, wherein the second processor is operably connected to the battery and the first processor, wherein the first processor consumes no power in a first mode, wherein the first processor consumes power via the battery in a second mode, wherein a power consumption of the second processor is less than a power consumption of the first processor in the second mode, wherein the one or more instructions, when executed by the second processor, cause the second processor to switch the first processor from the first mode to the second mode based on an external device being connected to the electronic apparatus while the first processor is in the first mode, and wherein the one or more instructions, when executed by the first processor, cause the electronic apparatus to: receive content from the external device, and control the display to display the received content.

According to an embodiment of the present disclosure, provided is an electronic apparatus including: a battery; a display; a first processor; and a second processor consuming less power than the first processor, wherein the second processor is configured to switch a first mode to a second mode in which the first processor consumes power via the battery if an external device is connected to the electronic apparatus while the first processor is in the first mode in which the first processor consumes no power, and the first processor is configured to receive content from the external device and control the display to display the received content.

The second processor may be configured to switch the first processor to the first mode if the received content is displayed on the display.

The apparatus may further include a switch for connecting the battery to the first processor, wherein the second processor is configured to control the switch, thereby switching the first processor to either the first mode or the second mode.

The second processor may be configured to switch the first processor to the second mode and transmit a wake-up signal to the first processor if the external device is connected to the electronic apparatus, and the first processor may be configured to supply power to the display connected to the first processor and at least one circuit connected to the first processor if the first processor switches to the second mode, and cut off power supply to the at least one circuit if the first processor receives the wake-up signal from the second processor.

The second processor may include a first signal pin that is at a high level, the external device may include a second signal pin that is grounded, and the second processor may be configured to identify the external device as being connected to the electronic apparatus if the second signal pin is short-circuited to the first signal pin and the high level thus switches to a low level.

The display may include an electronic paper (ePaper) display, and the ePaper display may be configured to maintain a display state of the content being displayed while power supply is cut off.

The ePaper display may be configured to be able to change the display state of the content being displayed while receiving power, and to be unable to change the display state of the content being displayed while receiving no power.

The electronic apparatus may be an apparatus that receive no external power source.

The apparatus may further include an input/output interface, wherein the external device is a universal serial bus (USB) device connected to the electronic apparatus via the input/output interface.

The second processor may be configured to constantly receive power via the battery.

According to an embodiment of the present disclosure, provided is control method of an electronic apparatus, the method including: switching, by a second processor included in the electronic apparatus and consuming less power than the first processor, a first mode to a second mode in which a first processor consumes power via a battery included in the electronic apparatus if an external device is connected to the electronic apparatus while the first processor included in the electronic apparatus is in the first mode in which the first processor consumes no power; receiving, by the first processor, content from the external device; and displaying the received content on a display included in the electronic apparatus.

The method may further include switching, by the second processor, the first processor to the first mode if the received content is displayed on the display.

In the switching to the second mode, the second processor may control a switch for connecting the battery to the first processor, thereby switching the first processor to the second mode, and in the switching to the first mode, the second processor may control the switch, thereby switching the first processor to the first mode.

The method, in which in the switching to the second mode, the second processor switches the first processor to the second mode and transmits a wake-up signal to the first processor if the external device is connected to the electronic apparatus, may further include: supplying power to the display connected to the first processor and at least one circuit connected to the first processor if the first processor receives power; and cutting off power supply to the at least one circuit if the first processor receives the wake-up signal from the second processor.

The second processor may include a first signal pin that is at a high level, the external device may include a second signal pin that is grounded, and in the switching to the second mode, the second processor may identify the external device as being connected to the electronic apparatus if the second signal pin is short-circuited to the first signal pin and the high level thus switches to a low level.

The display may include an ePaper display, and the ePaper display may maintain a display state of the content being displayed while power supply is cut off.

The ePaper display may change the display state of the content being displayed while receiving power, and to be unable to change the display state of the content being displayed receiving no power.

The electronic apparatus may be an apparatus that receive no external power source.

The external device may be a universal serial bus (USB) device connected to the electronic apparatus via an input/output interface included in the electronic apparatus.

The second processor may constantly receive power via the battery

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram showing a configuration of an electronic system according to one or more embodiments of the present disclosure;

FIG. 2 is a block diagram showing a configuration of the electronic apparatus according to one or more embodiments of the present disclosure;

FIG. 3 is a block diagram showing a detailed configuration of the electronic apparatus according to one or more embodiments of the present disclosure;

FIG. 4 is a diagram for describing an operation of the electronic apparatus based on each mode according to one or more embodiments of the present disclosure;

FIGS. 5, 6, 7, and 8 are diagrams for sequentially describing the operation based on a connection to the electronic apparatus by the external device according to one or more embodiments of the present disclosure;

FIG. 9 is a diagram for describing a method for identifying the connection by the external device according to one or more embodiments of the present disclosure;

FIG. 10 is a diagram for describing a signal output from a second processor according to one or more embodiments of the present disclosure; and

FIG. 11 is a flowchart for describing a control method of an electronic apparatus according to one or more embodiments of the present disclosure.

### DETAILED DESCRIPTION

The example embodiments of the present disclosure may be diversely modified. Accordingly, one or more specific example embodiments are illustrated in the drawings and are described in detail in the detailed description. However, it is to be understood that the present disclosure is not limited to a specific example embodiment, but includes all modifications, equivalents, and substitutions without departing from the scope and spirit of the present disclosure. Also, well-known functions or constructions are not described in detail since they would obscure the disclosure with unnecessary detail.

The present disclosure provides an electronic apparatus for changing content being displayed while reducing standby power consumption, and a control method thereof.

Hereinafter, embodiments of the present disclosure is described in detail with reference to the accompanying drawings. In the following description, like reference numerals refer to like elements throughout the specification.

General terms currently widely used are selected as terms used in embodiments of the present disclosure in consideration of their functions in the present disclosure, and may be changed based on the intentions of those skilled in the art or a judicial precedent, the emergence of a new technique, or the like. In addition, in a specific case, terms arbitrarily selected by an applicant may be present. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

In the specification, an expression “have”, “may have”, “include”, “may include”, or the like indicates the presence of a corresponding feature (for example, a numerical value, a function, an operation, or a component such as a part), and does not exclude the presence of an additional feature.

Expressions “first”, “second”, or the like used in the present disclosure may qualify various components regardless of the sequence or importance of the components. These expressions are used only to distinguish one component and another component from each other, and do not limit the corresponding components.

A term of a singular number may include its plural number unless explicitly indicated otherwise in the context. As used herein, the singular forms “a,” “an” and “the” are intended to include the plural forms as well, unless the context clearly indicates otherwise. It should be understood that a term “include”, “formed of”, or the like used in this application specifies the presence of features, numerals, steps, operations, components, parts, or combinations thereof, mentioned in the specification, and does not preclude the presence or addition of one or more other features, numerals, steps, operations, components, parts, or combinations thereof.

Terms such as “unit”, “module”, “member”, and “block” may be embodied as hardware or software. As used herein, a plurality of “units”, “modules”, “members”, and “blocks” may be implemented as a single component, or a single “unit”, “module”, “member”, and “block” may include a plurality of components.

Throughout the description, when a member is “on” another member, this includes not only when the member is in contact with the other member, but also when there is another member between the two members.

Herein, the expressions “at least one of a, b or c” and “at least one of a, b and c” indicate “only a,” “only b,” “only c,” “both a and b,” “both a and c,” “both b and c,” and “all of a, b, and c.”

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

The various actions, acts, blocks, steps, or the like in the flow diagrams may be performed in the order presented, in a different order, or simultaneously. Further, in one or more embodiments, some of the actions, acts, blocks, steps, or the like may be omitted, added, modified, skipped, or the like without departing from the scope of the disclosure.

It will be understood that when an element is referred to as being “connected” with or to another element, it can be directly or indirectly connected to the other element, wherein the indirect connection includes “connection via a wireless communication network”.

In the specification, a term “user” may refer to a person using an electronic apparatus or a device using the electronic apparatus (e.g., artificial intelligence electronic apparatus).

Hereinafter, various embodiments of the present disclosure are described in more detail with reference to the accompanying drawings.

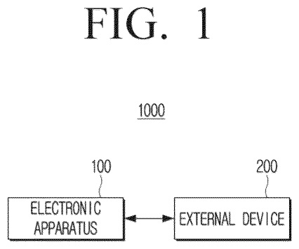

FIG. 1 is a block diagram showing a configuration of an electronic system 1000 according to one or more embodiments of the present disclosure. As shown in FIG. 1, the electronic system 1000 may include an electronic apparatus 100 and an external device 200.

The electronic apparatus 100 may be an apparatus that includes a display and displays content through the display. For example, the electronic apparatus 100 may be an apparatus that includes an electronic paper (ePaper) display and displays the content through the ePaper display, such as a desktop personal computer (PC), a television (TV), a laptop, a smartphone, a tablet PC, smart glasses, or a smart watch.

The electronic apparatus 100 may be an apparatus that does not receive an external power source. For example, the electronic apparatus 100 may be an apparatus that receives no external power source and receives power via a battery.

The electronic apparatus 100 may switch its mode from a first mode to a second mode, in which more power is consumed than in the first mode, if the external device 200 is connected thereto. The electronic apparatus 100 may receive the content from the external device 200 and display the received content if the external device 200 is connected thereto and the mode is switched to the second mode. The electronic apparatus 100 may switch the second mode to the first mode if the received content is displayed. However, the present disclosure is not limited thereto, and the electronic apparatus 100 may also switch the second mode to the first mode if the external device 200 is disconnected therefrom or if the content is displayed and then a predetermined time elapses.

The external device 200 may be an apparatus that stores the content and provides the content to the electronic apparatus 100 if connected to the electronic apparatus 100. For example, the external device 200 may be a universal serial bus (USB) device connected to the electronic apparatus 100.

However, the external device 200 is not limited thereto, and may be any device capable of providing the content to the electronic apparatus 100.

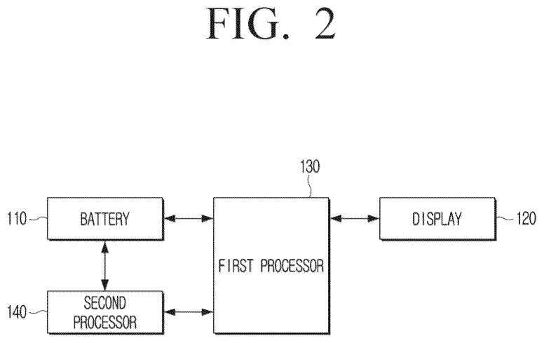

FIG. 2 is a block diagram showing a configuration of the electronic apparatus 100 according to one or more embodiments of the present disclosure.

Referring to FIG. 2, the electronic apparatus 100 may include a battery 110, a display 120, a first processor 130, and a second processor 140. However, the electronic apparatus 100 is not limited thereto, and may also be implemented by excluding some components.

The battery 110 may be charged by external power of the battery 110 and output charged power to provide power for driving each component of the electronic apparatus 100. Here, the battery 110 may include a rechargeable secondary battery or a fuel cell.

If the electronic apparatus 100 is in the first mode, the second processor 140 may receive power via the battery 110, and the other components of the electronic apparatus 100 may not be powered. If the electronic apparatus 100 is in the second mode, the first processor 130 and the second processor 140 may receive power via the battery 110. That is, the first mode may be a power-saving mode, and the second mode may be a normal mode.

The display 120 is a component for displaying the content, and may be the ePaper display. The ePaper display may maintain a display state of the content being displayed while power supply is cut off. The ePaper display may need to be powered to change the content being displayed thereon. For example, the ePaper display may change the display state of the content being displayed while receiving power, and cannot change the display state of the content being displayed while receiving no power.

The first processor 130 may control overall operations of the electronic apparatus 100. In detail, the first processor 130 may be connected to respective components of the electronic apparatus 100 and may control the overall operations of the electronic apparatus 100. For example, the first processor 130 may be connected to components such as the battery 110, the display 120, and the second processor 140 and control the operations of the electronic apparatus 100.

The first processor 130 may be implemented as at least one processor. Here, at least one processor may include at least one of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. At least one processor may control one or any combination of other components of the electronic apparatus 100, and perform operations related to communication or data processing. At least one processor may individually or collectively execute at least one program or instruction stored in a memory. For example, at least one processor may perform a method according to one or more embodiments of the present disclosure by executing at least one instruction stored in the memory.

If the method according to one or more embodiments of the present disclosure includes a plurality of operations, the plurality of operations may be performed by one processor, or may be performed by a plurality of processors. For example, if a first operation, a second operation, and a third operation are performed by the method according to one or more embodiments, the first operation, the second operation, and the third operation may all be performed by the first processor. Alternatively, the first operation and the second operation may be performed by the first processor (for example, a general-purpose processor), and the third operation may be performed by the second processor (for example, an artificial intelligence-only processor). For example, a process for quantizing a neural network model according to one or more embodiments of the present disclosure may be performed by the general-purpose processor, and a process for learning or inferring the quantized neural network model may be performed by an artificial intelligence-specific processor.

At least one processor may be implemented as a single-core processor including a single core, or may be implemented as at least one multi-core processor including multi-cores (for example, homogeneous multi-cores or heterogeneous multi-cores). If at least one processor 130 is implemented as the multi-core processor, each of the multi-cores included in the multi-core processor may include a processor internal memory such as a cache memory or an on-chip memory, and a common cache shared by the multi-cores may be included in the multi-core processor. In addition, each (or some) of the multi-cores included in the multi-core processor may independently read and perform a program instruction for implementing the method according to one or more embodiments of the present disclosure, or all (or some) of the multi-cores may be linked with each other to read and perform the program instruction for implementing the method according to one or more embodiments of the present disclosure.

If the method according to one or more embodiments of the present disclosure includes the plurality of operations, the plurality of operations may be performed by the single core among the multi-cores included in the multi-core processor, or may be performed by the multi-cores. For example, if the first operation, the second operation, and the third operation are performed using the method according to one or more embodiments, the first operation, the second operation, and the third operation may all be performed by a first core included in the multi-core processor. Alternatively, the first operation and the second operation may be performed by the first core included in the multi-core processor, and the third operation may be performed by a second core included in the multi-core processor.

In the embodiments of the present disclosure, at least one processor may indicate a system-on-chip (SoC) in which at least one processor and other electronic components are integrated with each other, the single-core processor, the multi-core processor, or the core included in the single-core processor or the multi-core processor. Here, the core may be implemented as the CPU, the GPU, the APU, the MIC, the DSP, the NPU, the hardware accelerator, the machine learning accelerator, or the like. However, the present disclosure is not limited thereto. However, for convenience of description, the operation of the electronic apparatus 100 is described below using the expression the “first processor 130”.

The first processor 130 may consume no power in the first mode, and may consume power in the second mode. For example, the first processor 130 may be turned off in the first mode in which the first processor 130 receives no power, and may be turned on in the second mode in which the first processor 130 receives power. If no power is supplied to the first processor 130, power may not be supplied to a configuration connected to the first processor 130 and receives power from the first processor 130. Whether power is supplied to the first processor 130 may be determined by the second processor 140. Here, the first mode may be the power-saving mode, and the second mode may be the normal mode.

However, the first processor 130 is not limited thereto. The first processor 130 may receive power even in the first mode, and may be turned off and consume no power. Alternatively, the first processor 130 may consume power even in the first mode. However, the first processor 130 may operate only some components of the first processor 130 or be operated at a lowered operating frequency to consume less power than in the second mode.

The second processor 140 may be a processor that consumes less power than the first processor 130. For example, the second processor 140 may be a low-power micro controller unit (MCU). However, the second processor 140 is not limited thereto, and may be any type of processor that consumes less power than the first processor 130. In one or more embodiments, the second processor may execute at least one program or instruction stored in a memory.

The second processor 140 may be in a state of continuously receiving power from the battery 110. That is, the second processor 140 may be in a state of receiving power from the battery 110 regardless of the mode of the electronic apparatus 100.

The second processor 140 may identify that the external device 200 is connected to the electronic apparatus 100 while the first processor 130 is in the first mode, in which the first processor 130 consumes no power. For example, the second processor 140 may identify whether the external device 200 is connected to the electronic apparatus 100 while the first processor 130 receives no power. For example, the second processor 140 may include a first signal pin that is at a high level, the external device 200 may include a second signal pin that is grounded, and the second processor 140 may identify the external device 200 as being connected to the electronic apparatus 100 if the second signal pin is short-circuited to the first signal pin and the high level thus switches to a low level. Here, the electronic apparatus 100 may further include an input/output interface, and the external device 200 may be the USB device connected to the electronic apparatus 100 via the input/output interface.

However, the second processor 140 is not limited thereto, and may identify whether the external device 200 is connected to the electronic apparatus 100 by using any of various methods.

The input/output interface may include at least one of a high definition multimedia interface (HDMI), a mobile high-definition link (MHL), a universal serial bus (USB), a display port (DP), Thunderbolt, a video graphics array (VGA) port, a red-green-blue (RGB) port, a D-subminiature (D-SUB), or a digital visual interface (DVI).

The input/output interface may input/output at least one of audio or video signals. For example, the input/output interface may include a port for inputting and outputting only the audio signal and a port for inputting and outputting only the video signal as its separate ports, or may be implemented as a single port for inputting and outputting both the audio signal and the video signal.

The second processor 140 may switch to the second mode in which the first processor 130 consumes power via the battery 110 if the external device 200 is connected to the electronic apparatus 100 while the first processor 130 is in the first mode in which the first processor 130 consumes no power. For example, the second processor 140 may supply power to the first processor 130 via the battery 110 if the external device 200 is connected to the electronic apparatus 100 while the first processor 130 receives no power. For example, the electronic apparatus 100 may further include a switch for connecting the battery 110 to the first processor 130, and the second processor 140 may control the switch, thereby supplying power to the first processor 130 via the battery 110.

The first processor 130 may receive the content from the external device 200 and control the display 120 to display the received content.

The second processor 140 may switch the first processor 130 to the first mode if the received content is displayed on the display 120. For example, the second processor 140 may cut off the power supply to the first processor 130 if the received content is displayed on the display 120. For example, the electronic apparatus 100 may further include the switch for connecting the battery 110 to the first processor 130, and the second processor 140 may control the switch, thereby switching the first processor 130 to either the first mode or the second mode.

The first processor 130 may control the display 120 to display the received content and then provide the second processor 140 with information indicating that the content is displayed. In this case, the second processor 140 may identify that the display state of the display 120 is changed based on the information received from the first processor 130 and switch the first processor 130 to the first mode. Alternatively, the second processor 140 may switch the first processor 130 to the second mode and change a flag value if the external device 200 is connected to the electronic apparatus 100. Next, the first processor 130 may control the display 120 to display the received content and then change the flag value, and the second processor 140 may switch the first processor 130 to the first mode based on the changed flag value.

However, the second processor 140 is not limited thereto, and may identify that the display state of the display 120 is changed using various methods.

The second processor 140 may switch the first processor 130 to the second mode and transmit a wake-up signal to the first processor 130 if the external device 200 is connected to the electronic apparatus 100. For example, the second processor 140 may supply power to the first processor 130 via the battery 110 and transmit the wake-up signal to the first processor 130 if the external device 200 is connected to the electronic apparatus 100. In this case, the first processor 130 may supply power to the display 120 connected to the first processor 130 and at least one circuit connected to the first processor 130 if the first processor 130 switches to the second mode, and may cut off power supply to at least one circuit if the first processor 130 receives the wake-up signal from the second processor 140. That is, if the first processor 130 receives the wake-up signal, the first processor 130 may further reduce power consumption by cutting off power supply to other components connected to the first processor 130, except for the display 120.

In this case, the electronic apparatus 100 may further include a third mode in addition to the first mode and the second mode. For example, the first mode refers to the power-saving mode in which power is supplied only to the second processor 140, the second mode refers to the normal mode in which power is supplied to all the components of the electronic apparatus 100, and the third mode refers to a mode in which power is supplied only to the display 120, the first processor 130, and the second processor 140.

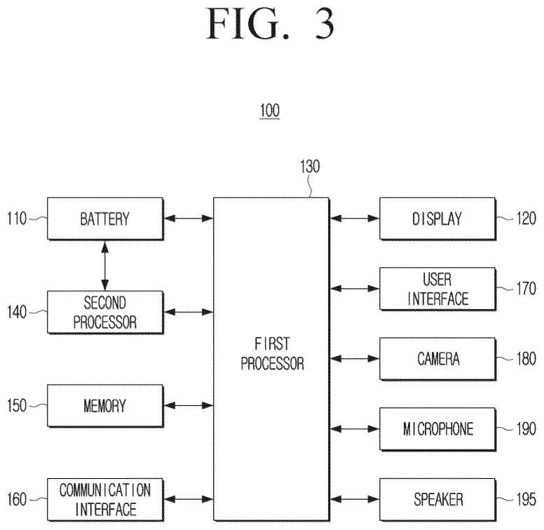

FIG. 3 is a block diagram showing a detailed configuration of the electronic apparatus 100 according to one or more embodiments of the present disclosure.

The electronic apparatus 100 may include the battery 110, the display 120, the first processor 130, and the second processor 140. In addition, referring to FIG. 3, the electronic apparatus 100 may further include a memory 150, a communication interface 160, a user interface 170, a camera 180, a microphone 190, and a speaker 195. The description omits detailed descriptions of the components shown in FIG. 3 that overlap with the components shown in FIG. 2

The memory 150 refers to hardware that stores information such as data in an electrical or magnetic form to enable the first processor 130 or the like to access the information. To this end, the memory 150 may be implemented as at least one hardware among a nonvolatile memory, a volatile memory, a flash memory, a hard disk drive (HDD), a solid state drive (SSD), a random access memory (RAM), a read only memory (ROM), or the like.

The memory 150 may store at least one instruction required for the operation of the electronic apparatus 100 or the first processor 130. Here, the instruction refers to a code unit that instructs the operation of the electronic apparatus 100 or the first processor 130, and may be written in a machine language, which is a language that a computer may understand.

The memory 150 may store data, which is information in bits or bytes that may represent characters, numbers, images, or the like. For example, the memory 150 may store the content.

The memory 150 may be accessed by the first processor 130, and the first processor 130 may perform reading/writing/modifying/deleting/updating on the instruction, an instruction set, or the data.

The communication interface 160 is a component for performing communication with various types of external devices by using various types of communication methods. For example, the electronic apparatus 100 may communicate with a server, an access point, and a user terminal device via the communication interface 160.

The communication interface 160 may include a wireless-fidelity (Wi-Fi) module, a Bluetooth module, an infrared communication module, and a wireless communication module. Here, each communication module may be implemented in the form of at least one hardware chip

The Wi-Fi module and Bluetooth module may perform the communication in a Wi-Fi manner and a Bluetooth manner, respectively. In case of using the Wi-Fi module or Bluetooth module, the communication interface 160 may first transmit and receive various connection information such as a service set identifier (SSID) or a session key, and connect the communication by using this connection information, and then transmit and receive various information. The infrared communication module may perform the communication based on infrared data association (IrDA) technology that wirelessly transmits data in a short distance using an infrared ray between optical waves and millimeter waves.

In addition to the above-described communication manners, the wireless communication module may include at least one communication chip performing the communication based on various wireless communication standards such as Zigbee, third generation (3G), 3rd generation partnership project (3GPP), long term evolution (LTE), LTE advanced (LTE-A), 4th generation (4G), and 5th generation (5G).

Alternatively, the communication interface 160 may include the input/output interface such as HDMI, DP, Thunderbolt, USB, RGB, D-SUB, or DVI.

In addition, the communication interface 160 may include at least one of wired communication modules performing the communication by using a local area network (LAN) module, an Ethernet module, a pair cable, a coaxial cable, or an optical fiber cable.

The user interface 170 may be implemented in a button, a touch pad, a mouse or a keyboard, or may also be implemented in a touch screen capable of performing both the display function and a manipulation input function. Here, the buttons may be various types of buttons, such as mechanical buttons, touch pads, wheels, or the like disposed on any region of a main body of the electronic apparatus 100, such as a front surface portion, a side surface portion or a rear surface portion.

The camera 180 is a component for capturing still images or moving images. The camera 180 may capture the still images at a specific time point, or capture the still images continuously.

The camera 180 may include a lens, a shutter, an aperture, a solid-state image sensor, an analog front end (AFE), and a timing generator (TG). In addition, the camera 180 may further include a cover glass in contact with the lens. The shutter may adjust a time at which light reflected from a subject enters the camera 180, and the aperture may mechanically increase or decrease a size of an opening through which light enters to adjust an amount of light incident on the lens. The solid-state image sensor may output the image by a photocharge as an electrical signal if light reflected from the subject is accumulated as the photocharge. The TG may output a timing signal for reading out pixel data of the solid-state image sensor, and the AFE may sample and digitize the electric signal output from the solid-state image sensor.

The microphone 190 is a component for receiving sound and converting the same into the audio signal. The microphone 190 may be electrically connected to the first processor 130 and receive sound under control of the first processor 130.

For example, the microphone 190 may be implemented as an integrated unit integrated with the upper portion, front portion, side portion, or the like of the electronic apparatus 100. Alternatively, the microphone 190 may be disposed on a remote control that is separate from the electronic apparatus 100. In this case, the remote control may receive sound via the microphone 190 and provide the received sound to the electronic apparatus 100.

The microphone 190 may include various components such as the microphone for collecting sound in an analog form, an amplifier circuit for amplifying the collected sound, an analog-to-digital (A/D) conversion circuit for sampling the amplified sound and converting the same into a digital signal, and a filter circuit for removing noise components from the converted digital signal.

The microphone 190 may be implemented in the form of a sound sensor, and may be implemented using any method for collecting sound.

The speaker 195 is a component for outputting various audio data processed by the first processor 130 as well as various notification sounds and voice messages.

Through the above-described operations, the electronic apparatus 100 may reduce the power consumption by supplying power only to the second processor 140, which consumes relatively less power than the first processor 130, if no special event occurs, such as the external device 200 being connected to the electronic apparatus 100. In addition, if the external device 200 is connected to the electronic apparatus 100, power may be supplied to the first processor 130, thereby changing the display state of the display 120, and then power supply to the first processor 130 may be cut off again. That is, even if a user does not perform any separate manipulation, such as switching the mode of the electronic apparatus 100, the display state of the display 120 may be changed merely by connecting the external device 200 to the electronic apparatus 100, thereby improving user convenience.

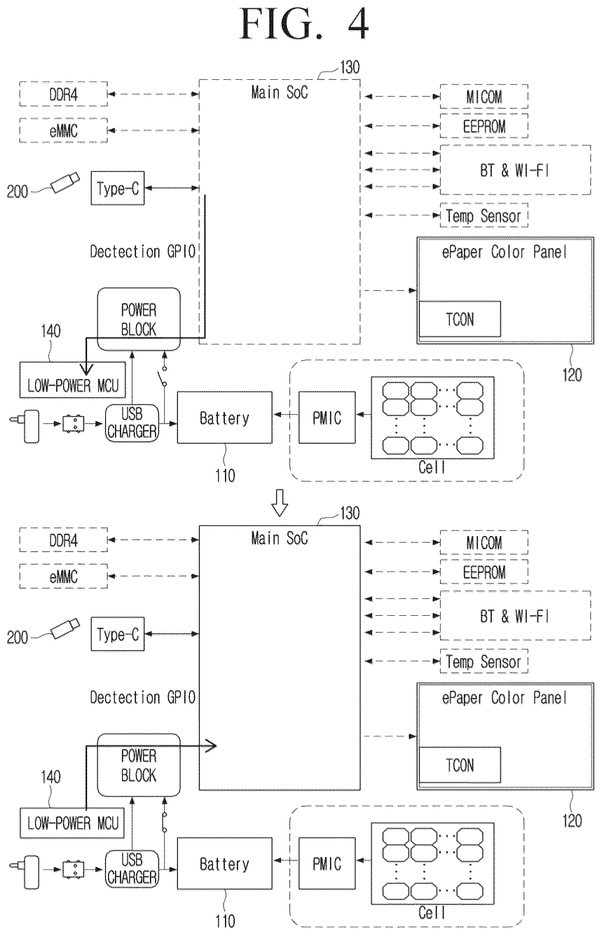

Hereinafter, the operation of the electronic apparatus 100 is described in more detail with reference to FIGS. 4 to 10. The description describes individual embodiments for the convenience of description with reference to FIGS. 4 to 10. However, the individual embodiments shown in FIGS. 4 to 10 may be implemented in any combination.

FIG. 4 is a diagram for describing the operation of the electronic apparatus 100 in each mode according to one or more embodiments of the present disclosure.

As shown in an upper part of FIG. 4, if the electronic apparatus 100 is in the first mode, the second processor (e.g., low-power MCU) 140 may receive power from the battery 110, and the first processor (Main SoC) 130 and at least one circuit connected to the first processor 130 may receive no power from the battery 110. At least one circuit connected to the first processor 130 may include RAM (double data rate 4 (DDR4)), storage space (embedded multimedia card (eMMC)), microcontroller unit (MICOM), the communication interface (Bluetooth (BT) & WI-FI), or the like. At least one circuit connected to the first processor 130 may include the display (ePaper color panel) 120, and the display 120 may be the ePaper display and maintain the display state of the content being displayed even if the power supply is cut off. However, the ePaper display may be in a state of receiving no power, and thus be unable to change the display state of the content being displayed.

The battery 110 may be charged via a solar cell and a power management integrated circuit (PMIC). However, the battery 110 is not limited thereto, and may also be charged via the external power source. The battery 110 may continuously supply power to the second processor 140. The battery 110 may provide power to a power block corresponding to the first processor 130 via a switch. Here, the switch may be controlled by the second processor 140.

The second processor 140 may identify whether the external device 200 is connected to the electronic apparatus 100. For example, the second processor 140 may include the first signal pin that is at a high level, the external device 200 may include the second signal pin that is grounded, and the second processor 140 may identify that the external device 200 is connected to the electronic apparatus 100 if the second signal pin is short-circuited to the first signal pin and the high level thus switches to the low level. Here, the first signal pin may be a general-purpose input/output (GPIO) signal pin.

The upper part of FIG. 4 shows that the first signal pin of the second processor 140 is connected to the second signal pin of the external device 200 via the first processor 130. That is, the first signal pin of the second processor 140 may be connected to one of the plurality of signal pins of the first processor 130, the second signal pin of the external device 200 may be connected to another of the plurality of signal pins of the first processor 130, and one and another of the plurality of signal pins of the first processor 130 may be short-circuited. If the external device 200 is in a state of being not connected to the electronic apparatus 100, one and another of the plurality of signal pins of the first processor 130 may be at a high level state by the first signal pin.

However, the present disclosure is not limited to the first signal pin of the second processor 140, and the second signal pin of the external device 200 may be connected without going through the first processor 130.

The second processor 140 may control the switch to enable power from the battery 110 to be provided to the power block corresponding to the first processor 130, as shown in a lower part of FIG. 4, if the external device 200 is identified as being connected to the electronic apparatus 100 while the first processor 130 receives no power. In addition, the second processor 140 may transmit the wake-up signal to the first processor 130.

The first processor 130 may supply power to the display 120 connected to the first processor 130 and at least one circuit connected to the first processor 130 if the first processor 130 receives power, and may cut off power to at least one circuit if the first processor 130 receives the wake-up signal from the second processor 140.

The first processor 130 may receive the content from the external device 200 and control the ePaper display to display the received content. The ePaper display may be in a state of receiving power, and thus be able to change the display state of the content being displayed based on the control of the first processor 130.

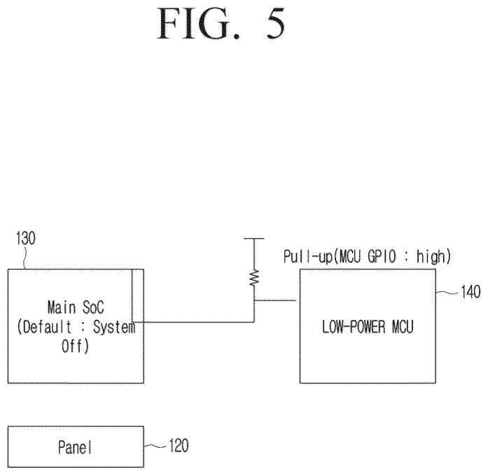

FIGS. 5 to 8 are diagrams for sequentially describing the operation based on the connection to the electronic apparatus by the external device 200 according to one or more embodiments of the present disclosure.

The electronic apparatus 100 may be in the first mode before the external device 200 is connected thereto. For example, as shown in FIG. 5, the first processor (Main SoC) 130 and the display (panel) 120 may receive no power, and the second processor (low-power MCU) 130 may receive power.

The second processor 140 may include the first signal pin at a high level, and the first signal pin may be connected to one of the plurality of signal pins of the first processor 130. The external device 200 may be in the state of being not connected to the electronic apparatus 100, and accordingly, another of the plurality of signal pins of the first processor 130 may be in an open state, and both one of the plurality of signal pins, which is connected to another of the plurality of signal pins and the first signal pin, may be in a state of conducting no current and may be at the high level.

The display 120 may be in a state of displaying the first content under the control of the first processor 130 before the electronic apparatus 100 enters the first mode. The display may be in the state of receiving no power if the electronic apparatus 100 enters the first mode, and implemented as the ePaper display and may maintain the display state of the content being displayed.

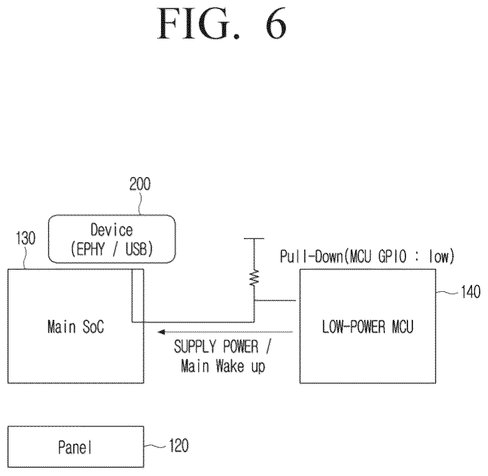

Next, the external device 200 may be connected to the electronic apparatus 100. For example, as shown in FIG. 6, if the external device (or device) 200 is connected to the electronic apparatus 100, the grounded second signal pin of the external device 200 may be connected to another of the plurality of signal pins of the first processor 130. In this case, by the grounded second signal pin, one of the plurality of signal pins of the first processor 130 and the first signal pin of the second processor 140 may also be grounded. That is, the second processor 140 may identify that the external device 200 is connected to the electronic apparatus 100 as the first signal pin switches from the high level to the low level.

The second processor 140 may supply power to the first processor 130 via the battery 110 and transmit the wake-up signal to the first processor 130 if the external device 200 is connected to the electronic apparatus 100.

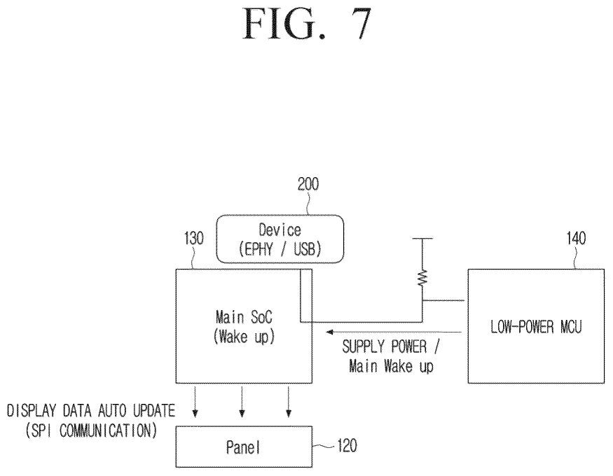

If the first processor 130 receives power, the first processor 130 may change the display state of the display. For example, as shown in FIG. 7, the first processor 130 may supply power to the display 120 connected to the first processor 130 and at least one circuit connected to the first processor 130 if the first processor 130 receives power, and may cut off the power to at least one circuit if the first processor 130 receives the wake-up signal from the second processor 140.

The first processor 130 may receive second content stored in the external device 200 from the external device 200, and change first content displayed on the display 120 to the second content. As power is supplied to the first processor 130, power may also be supplied to the display 120, and the display state of the display 120 may be changed as the display 120 receives power.

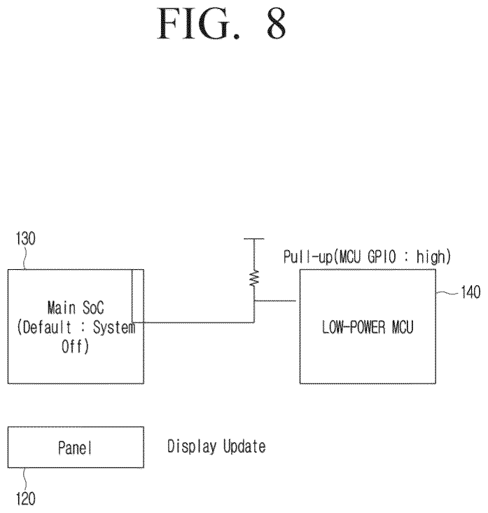

Next, if the external device 200 is disconnected from the electronic apparatus 100, the electronic apparatus 100 may switch the mode of the electronic apparatus 100 to the first mode. For example, as shown in FIG. 8, if the external device 200 is disconnected from the electronic apparatus 100, another of the plurality of signal pins of the first processor 130 is open, and both one of the plurality of signal pins that is connected to another of the plurality of signal pins and the first signal pin of the second processor 140 may be changed to the state of conducting no current. That is, the second processor 140 may identify that the external device 200 is disconnected from the electronic apparatus 100 as the first signal pin switches from the low level to the high level.

The second processor 140 may cut off the power supply to the first processor 130 if the external device 200 is identified as being disconnected from the electronic apparatus 100.

However, the second processor 140 is not limited thereto. The second processor 140 may identify the display state of the display 120 and cut off the power supply to the first processor 130. Alternatively, the first processor 130 may provide the second processor 140 with information indicating that the display state of the display 120 is changed, and the second processor 140 may cut off the power supply to the first processor 130 based on the information received from the first processor 130.

If the power supply to the first processor 130 is cut off, the power supply to the display 120 connected to the first processor 130 may also be cut off. However, the display 120 is the ePaper display, and thus maintain the display state of the second content being displayed while the power supply is cut off.

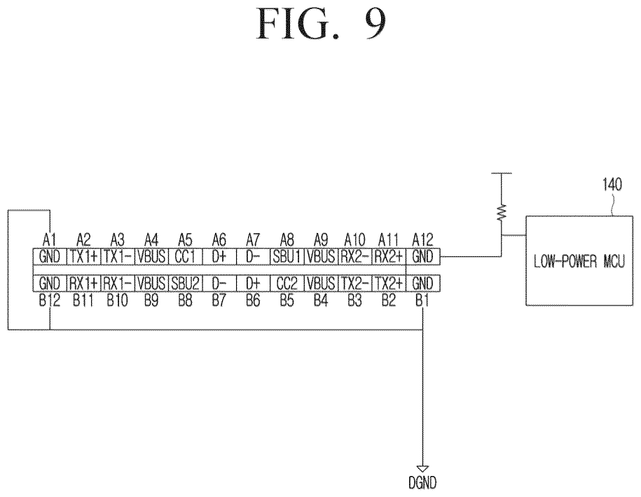

FIG. 9 is a diagram for describing a method for identifying the connection by the external device 200 according to one or more embodiments of the present disclosure.

The second processor 140 may include the first signal pin at a high level, as shown in FIG. 9, and the external device 200 may include a second signal pin A12 that is grounded.

The second processor 140 may identify the external device 200 as being connected to the electronic apparatus 100 if the second signal pin is short-circuited to the first signal pin and the high level thus switches to the low level.

For the convenience of description, FIG. 9 shows that the first signal pin is directly connected to the second signal pin. However, the present disclosure is not limited thereto. For example, the first signal pin may be connected to the second signal pin via the first processor 130. For example, the first signal pin may be connected to one of the plurality of signal pins of the first processor 130, and the second signal pin may be connected to another of the plurality of signal pins of the first processor 130. One and another of the plurality of signal pins of the first processor 130 may be in a state of being short-circuited to each other, and a circuit configuration may remain unchanged regardless of whether the first processor 130 receives power. That is, one and another of the plurality of signal pins of the first processor 130 may be in a state of being physically connected to each other, and accordingly, voltages of one and another of the plurality of signal pins of the first processor 130 may be the same as each other even if the first processor 130 receives no power.

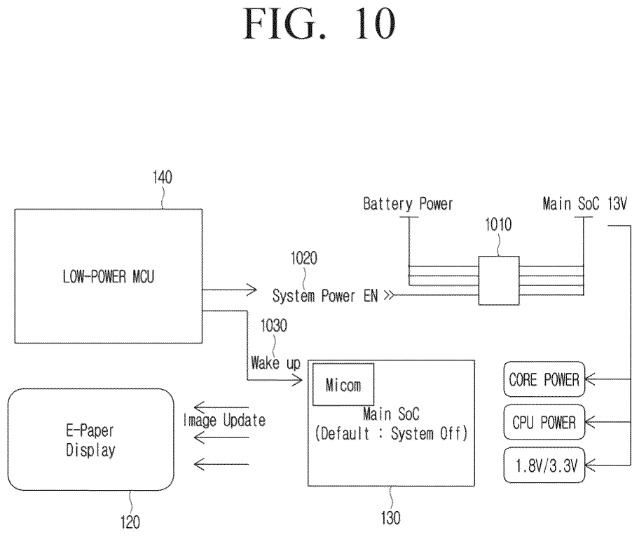

FIG. 10 is a diagram for describing a signal output from the second processor 140 according to one or more embodiments of the present disclosure.

The second processor 140 may supply power to the first processor 130 via the battery 110 and transmit the wake-up signal to the first processor 130 if the external device 200 is connected to the electronic apparatus 100.

For example, as shown in FIG. 10, if the external device 200 is connected to the electronic apparatus 100, the second processor 140 may supply power such as core power, CPU power, and 1.8 V, 3.3 V or the like to the first processor 130 via the battery 110 by applying a signal from a high-level system power enable (EN) 1020 to a switch 1010 for connecting the battery 110 to the first processor 130.

If the first processor 130 receives power, the display 120 connected to the first processor 130 and at least one circuit connected to the first processor 130 may also receive power.

The first processor 130 may cut off the power supply to at least one circuit if the first processor 130 receives the wake-up signal from the second processor 140. For example, the first processor 130 may cut off the power supply to at least one circuit if the first processor 130 receives the wake-up signal 1030 from the second processor 140.

However, the first processor 130 may maintain the power supply to the display 120 and may change the display state of the display 120 (Image Update).

The second processor 140 may cut off the power supply to the first processor 130 if the display state of the display 120 is changed. For example, the second processor 140 may cut off the power supply to the first processor 130 by switching the signal of the system power EN 1020 from the high level to the low level.

If the power supply to the first processor 130 is cut off, the power supply to the display 120 connected to the first processor 130 may also be cut off. However, the first processor 130 is not limited to, and may change the display state of the display 120 and then cut off the power supply to the display 120. Through this operation, power consumed by the display 120 may be further reduced.

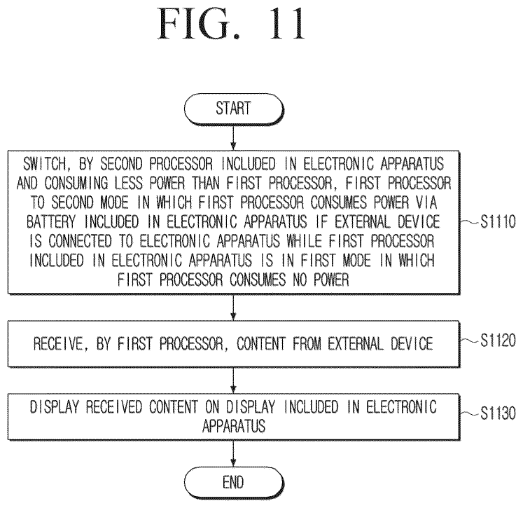

FIG. 11 is a flowchart for describing a control method of an electronic apparatus according to one or more embodiments of the present disclosure.

First, the control method may include switching, by the second processor included in the electronic apparatus and consuming less power than the first processor, a first mode to the second mode in which the first processor consumes power via the battery included in the electronic apparatus if the external device is connected to the electronic apparatus while the first processor included in the electronic apparatus is in the first mode in which the first processor consumes no power (S1110). In addition, the control method may include receiving, by the first processor, the content from the external device (S1120). In addition, the control method may include displaying the received content on the display included in the electronic apparatus (S1130).

In addition, the control method may further include switching, by the second processor, the first processor to the first mode if the received content is displayed on the display.

In addition, in the switching to the second mode (S1110), the second processor may control the switch for connecting the battery to the first processor, thereby switching the first processor to the second mode, and in the switching to the first mode, the second processor may control the switch, thereby switching the first processor to the first mode.

In addition, in the switching to the second mode (S1110), the second processor may switch the first processor to the second mode and transmit the wake-up signal to the first processor if the external device is connected to the electronic apparatus, and the control method may further include supplying power to the display connected to the first processor and at least one circuit connected to the first processor if the first processor switches to the second mode, and cutting off the power supply to at least one circuit if the first processor receives the wake-up signal from the second processor.

In addition, the second processor may include the first signal pin at a high level, the external device may include the second signal pin that is grounded, and in the switching to the second mode (S1110), the external device may be identified as being connected to the electronic apparatus if the second signal pin is short-circuited to the first signal pin and the high level thus switches to the low level.

In addition, the display may include the ePaper display, and the ePaper display may maintain the display state of the content being displayed while the power supply is cut off.

In addition, the ePaper display is able to change the display state of the content being displayed while receiving power, and is unable to change the display state of the content being displayed while receiving no power.

In addition, the electronic apparatus may be an apparatus that receives no external power source.

In addition, the external device may be the USB device connected to the electronic apparatus via the input/output interface included in the electronic apparatus.

In addition, the second processor may continuously receive power via the battery.

As described above, the electronic apparatus may reduce the power consumption by supplying power only to the second processor, which consumes relatively less power than the first processor, if no special event occurs, such as the external device being connected to the electronic apparatus.

In addition, if the external device is connected to the electronic apparatus, power may be supplied to the first processor to change the display state of the display, and then power supply to the first processor again may be cut off. That is, the user may change the display state of the display merely by connecting the external device to the electronic apparatus without performing any separate manipulation such as switching the mode of the electronic apparatus, thereby improving the user convenience.

According to one or more embodiments of the present disclosure, the one or more embodiments described above may be implemented in software including an instruction stored on a machine-readable storage medium (for example, a computer-readable storage medium). A machine may be a device that invokes the stored instruction from a storage medium, may be operated based on the invoked instruction, and may include the electronic apparatus (e.g., electronic apparatus A) according to the disclosed embodiments. If the instruction is executed by the processor, the processor may directly perform a function corresponding to the instruction or other components may perform the function corresponding to the instruction under the control of the processor. The instruction may include codes generated or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored on the storage medium.

In addition, according to one or more embodiments of the present disclosure, the methods according to the one or more embodiments described above may be included and provided in a computer program product. The computer program product may be traded as a commodity between a seller and a purchaser. The computer program product may be distributed in a form of the machine-readable storage medium (for example, a compact disc read only memory (CD-ROM)), or may be distributed online through an application store (for example, PlayStore™. In case of the online distribution, at least a portion of the computer program product may be at least temporarily stored or temporarily generated on a storage medium such as the memory of a manufacturer server, an application store server, or a relay server.

In addition, according to one or more embodiments of the present disclosure, the one or more embodiments described above may be implemented in a recording medium readable by a computer or similar device using software, hardware, or a combination thereof. In some cases, the embodiments described in the specification may be implemented by the processor itself. In software implementation, the embodiments such as the procedures and functions described in the specification may be implemented by separate software modules. Each of the software modules may perform one or more functions and operations described in the specification.

A non-transitory computer-readable medium may store computer instructions for performing processing operations of the device according to the one or more embodiments described above. The computer instructions stored in the non-transitory computer-readable medium may allow a specific device to perform the processing operations of the device according to the one or more embodiments described above if executed by a processor of the specific device. The non-transitory computer-readable medium indicates a medium that semi-permanently stores data therein and is readable by the machine instead of a medium that stores data therein temporarily, such as a register, a cache, or a memory. A specific example of the non-transitory computer-readable medium may include a compact disk (CD), a digital versatile disk (DVD), a hard disk, a Blu-ray disk, a universal serial bus (USB), a memory card, a read only memory (ROM), or the like.

In addition, each of the components (for example, modules or programs) according to the one or more embodiments described above may include a single entity or a plurality of entities, and some of the corresponding sub-components described above may be omitted or other sub-components may be further included in the one or more embodiments. Alternatively or additionally, some of the components (for example, the modules or the programs) may be integrated into the single entity, and may perform functions performed by the respective corresponding components before being integrated in the same or similar manner. Operations performed by the modules, the programs, or other components according to the one or more embodiments may be executed in a sequential manner, a parallel manner, an iterative manner, or a heuristic manner, at least some of the operations may be performed in a different order or be omitted, or other operations may be added.

Although the embodiments of the present disclosure are shown and described as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. An electronic apparatus comprising:
a battery;
a display;
memory storing instructions;
at least one first processor configured to execute the instructions, wherein the at least one first processor is operably connected to the battery, the display, and the memory; and
a second processor operably connected to the battery and the at least one first processor,
wherein the at least one first processor consumes no power in a first mode,
wherein the at least one first processor consumes power via the battery in a second mode,
wherein a power consumption of the second processor is less than a power consumption of the at least one first processor in the second mode,
wherein the second processor is configured to switch the at least one first processor from the first mode to the second mode based on an external device being connected to the electronic apparatus while the at least one first processor is in the first mode, and
wherein the instructions, when executed by the at least one first processor individually or collectively, cause the electronic apparatus to:
receive content from the external device, and
control the display to display the received content.

2. The electronic apparatus of claim 1, wherein the second processor is further configured to switch the at least one first processor to the first mode based on the received content being displayed on the display.

3. The electronic apparatus of claim 2, further comprising a switch connecting the battery to the at least one first processor,
wherein the second processor is further configured to switch the at least one first processor to either the first mode or the second mode by operating the switch.

4. The electronic apparatus of claim 1, wherein the second processor is further configured to transmit a wake-up signal to the at least one first processor based on the external device being connected to the electronic apparatus, and
wherein the instructions, when executed by the at least one first processor individually or collectively, further cause the electronic apparatus to:
based on the at least one first processor being switched to the second mode, supply power to the display and at least one circuit connected to the at least one first processor, and
based on the at least one first processor receiving the wake-up signal, cut off power to the at least one circuit.

5. The electronic apparatus of claim 1, wherein the second processor comprises a first signal pin that is at a high level,
wherein the external device comprises a second signal pin that is grounded, and
wherein the second processor is further configured to identify that the external device is connected to the electronic apparatus based on the second signal pin being short-circuited to the first signal pin, causing the first signal pin to switch to a low level.

6. The electronic apparatus of claim 1, wherein the display comprises an electronic paper (ePaper) display, and
wherein the ePaper display is configured to maintain a display state of the displayed received content while not receiving power.

7. The electronic apparatus of claim 6, wherein the ePaper display is further configured to:
change the display state of the displayed received content while receiving power, and
not change the display state of the displayed received content while not receiving power.

8. The electronic apparatus of claim 1, wherein the electronic apparatus is not connected to an external power source.

9. The electronic apparatus of claim 1, further comprising an input/output interface,
wherein the external device comprises a universal serial bus device connected to the electronic apparatus via the input/output interface.

10. The electronic apparatus of claim 1, wherein the second processor is further configured to continuously receive power via the battery.

11. A method of controlling an electronic apparatus, the method comprising:
switching, by a second processor of the electronic apparatus, at least one first processor of the electronic apparatus from a first mode to a second mode based on an external device being connected to the electronic apparatus while the at least one first processor is in the first mode;
receiving, by the at least one first processor, content from the external device; and
displaying the received content on a display of the electronic apparatus,
wherein the at least one first processor consumes no power in the first mode,
wherein the at least one first processor consumes power via a battery of the electronic apparatus in the second mode, and
wherein a power consumption of the second processor is less than a power consumption of the at least one first processor in the second mode.

12. The method of claim 11, further comprising switching, by the second processor, the at least one first processor to the first mode based on the received content being displayed on the display.

13. The method of claim 12, wherein the switching the at least one first processor to the second mode further comprises operating, by the second processor, a switch of the electronic apparatus connecting the battery to the at least one first processor, and
wherein the method further comprises:
operating, by the second processor, the switch while the at least one first processor is in the second mode, thereby switching the at least one first processor to the first mode.

14. The method of claim 11, wherein the switching the at least one first processor to the second mode further comprises:
transmitting a wake-up signal to the at least one first processor based on the external device being connected to the electronic apparatus, and
wherein the method further comprises:
based on the at least one first processor being switched to the second mode, supplying power to the display and at least one circuit of the electronic apparatus connected to the at least one first processor; and
based on the at least one first processor receiving the wake-up signal, cutting off power to the at least one circuit.

15. The method of claim 11, wherein the second processor comprises a first signal pin that is at a high level,
wherein the external device comprises a second signal pin that is grounded, and
wherein the switching the at least one first processor to the second mode further comprises:
identifying, by the second processor, that the external device is connected to the electronic apparatus based on the second signal pin being short-circuited to the first signal pin, causing the first signal pin to switch to a low level.

16. A non-transitory computer readable medium having instructions stored therein, which when executed by a first processor and a second processor of an electronic apparatus, cause the electronic apparatus to execute a method of operation, the method comprising:
switching, by the second processor, the first processor from a first mode to a second mode based on an external device being connected to the electronic apparatus while the first processor is in the first mode;
receiving, by the first processor, content from the external device; and
displaying the received content on a display of the electronic apparatus,
wherein the first processor consumes no power in the first mode,
wherein the first processor consumes power via a battery of the electronic apparatus in the second mode, and
wherein a power consumption of the second processor is less than a power consumption of the first processor in the second mode.

17. The non-transitory computer readable medium of claim 16, wherein the method further comprises switching, by the second processor, the first processor to the first mode based on the received content being displayed on the display.

18. The non-transitory computer readable medium of claim 17, wherein the switching the first processor to the second mode further comprises operating, by the second processor, a switch of the electronic apparatus connecting the battery to the first processor, and
wherein the method further comprises:
operating, by the second processor, the switch while the first processor is in the second mode, thereby switching the first processor to the first mode.

19. The non-transitory computer readable medium of claim 16, wherein the switching the first processor to the second mode further comprises:
transmitting a wake-up signal to the first processor based on the external device being connected to the electronic apparatus, and
wherein the method further comprises:
based on the first processor being switched to the second mode, supplying power to the display and at least one circuit of the electronic apparatus connected to the first processor; and
based on the first processor receiving the wake-up signal, cutting off power to the at least one circuit.

20. The non-transitory computer readable medium of claim 16, wherein the second processor comprises a first signal pin that is at a high level,
wherein the external device comprises a second signal pin that is grounded, and
wherein the switching the first processor to the second mode further comprises:
identifying, by the second processor, that the external device is connected to the electronic apparatus based on the second signal pin being short-circuited to the first signal pin, causing the first signal pin to switch to a low level.
